(19) United States
(12) Patent Application Publication
(10) Pub. No.: US 2009/0171923 A1
(43) Pub. Date: Jul. 2, 2009

(54) Domain-specific concept model for associating structured data that enables a natural language query

(76) Inventors: Michael Patrick Nash, Saskatoon (CA); Ryan Scott Breidenbach, Coppell, TX (US); Roderick F. Coffin, III, Dallas, TX (US); Kelly Christopher Fox, Austin, TX (US); Ben Rady, Dallas, TX (US); Daniel L. James, Annetta, TX (US); Paul Randolph Holser, JR., Addison, TX (US); Ruby Bailey, McKinney, TX (US); Craig Walls, Plano, TX (US)

Correspondence Address: Steven Thrasher, 391 Sandhill Dr., Richardson, TX, 75080, US

(21) Appl. No.: 12/079,792

(22) Filed: Mar. 28, 2008

Related U.S. Application Data
(60) Provisional application No. 61/009,815, filed on Jan. 2, 2008.

(51) Int. Cl. G06F 17/30

(52) U.S. Cl. 707/4; 707/E17.015

(57) ABSTRACT

The invention defines a domain specific concept model that is flexible, intuitive, and which easily integrates into disparate, but similarly architected, domain-specific databases. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CROSS-REFERENCE TO RELATED APPLICATION

The invention is related to and claims priority from pending U.S. Provisional Patent Application No. 61/009,815 to Lane, et al., entitled NATURAL LANGUAGE DATABASE QUERYING filed on 2 Jan. 2008.

### TECHNICAL FIELD OF THE INVENTION

The present invention relates generally to structured data querying, and more particularly to natural language database querying.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Database querying is generally limited to structured queries written in archaic language practically understandable by only those who have received special training in database programming. Recently, attempts have been made to generate “natural language” queries, however, these “solutions” involve a significant amount of menu-driven selecting of terms and relations to guide a user to ask the “right” question. This solution is burdensome, and entirely unsatisfactory to most users. Further, existing database structures impose on the end user the use of that archaic programming language that is too burdensome for most potential end-users to master. The present invention solves the problem of rigid database structure by providing a structure that is flexible, intuitive, and which easily integrates into disparate, but similarly architected, domain-specific databases.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 is a generic domain-specific concept model architected according to the invention.

FIG. 2 is an exemplary domain-specific concept model.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium and/or in a data storage (“data store”) either locally or on a remote computing platform, such as an application service provider, for example. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Computing platforms are computers, such as personal computers, workstations, servers, or sub-systems of any of the aforementioned devices. Further, a computing platform may be segmented by functionality into a first computing platform, second computing platform, etc. such that the physical hardware for the first and second computing platforms is identical (or shared), where the distinction between the devices (or systems and/or sub-systems, depending on context) is defined by the separate functionality which is typically implemented through different code (software).

Of course, the foregoing discussions and definitions are provided for clarification purposes and are not limiting. Words and phrases are to be given their ordinary plain meaning unless indicated otherwise.

### Description of the Drawings

Prior art domain specific concept models are identified and generally discussed in the OWL database programming language standard. The domain-specific concept model architecture of the present invention adds to the prior art in manners not readily apparent to those of ordinary skill in the art.

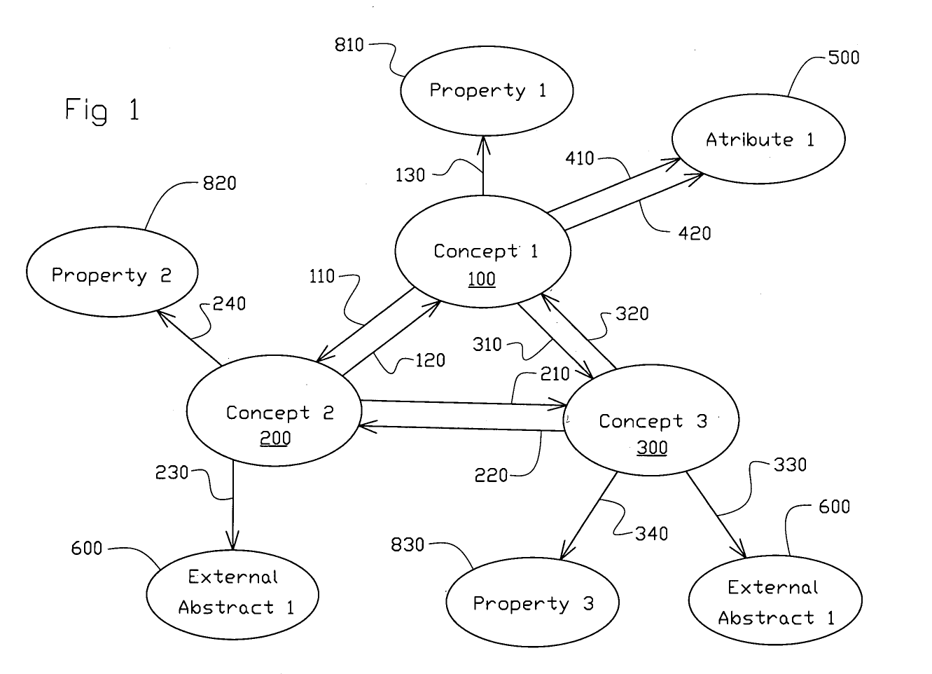

FIG. 1 is a generic domain-specific concept model architected according to the invention. Generally, the invention comprises a plurality of concepts, each concept comprising at least one element. The concepts of the invention are words that have a macro-meaning--stated differently, concepts have an identity associated with a macro meaning. Thus, the term used to name a concept describes a general category of a noun or noun phrase—a person-type, place, thing, or group.

Here, the concepts comprise a first concept 100, a second concept 200, and a third concept 300, and may comprise any number of a plurality of concepts. Each concept is related to at least one of the other concepts or an attribute by a word or phrase called a “relation” or alternatively a “relationship.” Accordingly, the invention architecture includes a plurality of relations, each relation defining how each concept relates to a property, an attribute, or a value. In FIG. 1 is seen a plurality of relations including a first relation 1A 110, a second relation 1B 120, a third relation 4A 410 from the first concept 100 to a first attribute 500, a fourth relation 4B 420, a fifth relation 2C 230, a sixth relation 3C 330 and other relations 1C 130 to a first property 810, 2A 210 from the second concept 200 to the third concept 300, 2B 220 from the third concept 300 to the second concept 200, 2D 240 to the second property 820, 3A 310 from the third concept 300 to the first concept 100, 3B 320 from the first concept 100 to the third concept 300, and 3D 340 to a third property 830.

In practice, each relation is typically a verb, participle, or verb phrase, and relations that relate concepts to concepts or concepts to attribute have corresponding reverse relations. As shown in FIG. 1, relations to properties or external abstracts may exist in the direction of from a concept and to the property or attribute.

Typically, a domain specific concept model according to the invention includes a plurality of attributes comprising the first attribute 500, where an attribute is generally defined as information about the concept to which the attribute is related. One exemplary attribute could be a “territory” belonging to an “employee” or “sales representative” concept. Attributes of the invention may be complex data types, meaning that they may be associated with more than one data value.

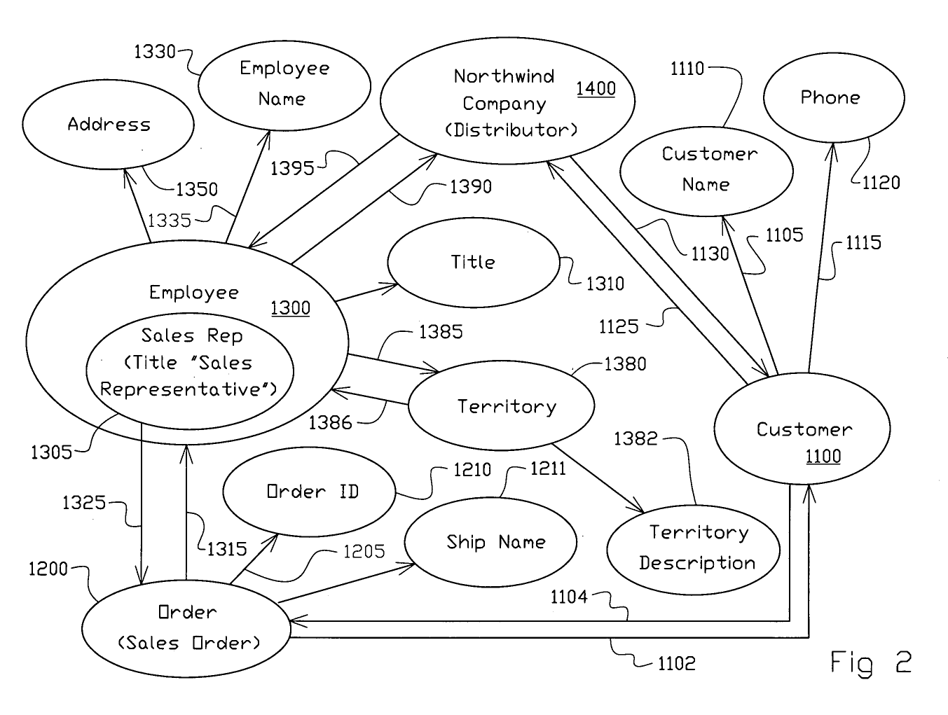

One aspect of the invention is that concepts may be associated with at least one synonym. For example, as seen in FIG. 2 (discussed below) a first concept “customer” 1100 may be synonymous with client, stakeholder, ticket purchaser, or attendee, for example. Similarly, the second concept “order” 1200 may be synonymous with ticket, bill, or other “order” identifier. Synonyms may also be associated with each relation. For example, the first relation 1102 “placed by” could also be identified with the synonyms “entered by”, “called in” and/or “selected”, for example.

A property generally describes a concept or an attribute that the property is related to, and includes object properties and data properties. For example, a concept named “account” may have properties that include: account number, account name, credit limit, phone number, email address, preferred contact method, and/or account type, for example. Further, a property value may have an equivalent property value identified by an alternative nomenclature. For example, “customer name” may also be identified as “client name.”

In some instances, information may be abstracted across many concepts and attributes. Examples of such information include cities, countries, addresses, and various codes that identify groups (such as postal codes), and the set of each information abstract is known as an “external abstract.” In FIG. 1, the second concept 200 and the third concept 300 are each mapped to a common external abstract 600, the second concept 200 being mapped to the external abstract by the fifth relation 230, the third concept 300 being mapped to the external abstract 600 by the sixth relation 330.

Problems are often encountered when combining concept models from disparate data sources. In such instances, different concept names may refer to the same concept and corresponding relations, properties, and data. Accordingly, to accommodate this problem, when combining synonymous concepts a first property value may be an abstraction of an equivalent property value. Preferably, the equivalent property value is a natural language word. However, names that are abstract (or non-whimsical) may be given to a concept or property. For example a concept or property comprising employees may also be named “8A” or any other name in order to reduce ambiguity between disparate concepts having similar names.

Turn again to FIG. 2, which is an exemplary domain-specific concept model (it is “domain specific” in the sense that it is a concept model that specifically defines and represents the relationships in a data set called “Northwind.” The concept model comprises a “customer” concept 1100, an “order” concept 1200, a “company” concept 1400, and an “employee” concept 1300 that wholly includes a “sales rep” property 1305. The “customer” concept 1100 is related to property “customer name” 1110 by a relation called “named” 1105, and property called “phone” 1120 by a relation named “having phone” 1115. “Customer” concept 1100 is related to “company” concept 1400 by the “buys from” relation 1125 and the “sells to” reverse relation 1130, as well as the “order” concept 1200 via the “who placed” relation 1104 and the “placed by” 1102 reverse relation. “Order” concept 1200 is related to the “order ID” property 1210 via the “having ID” relation 1205. Further, the “order” concept 1200 is related to both the “employee” concept 1300 and the “sales rep” property 1305 via the “written by” relation 1315 and the “who wrote” reverse relation 1325.

The “employee” concept 1300 is related to the “company” concept 1400 via a “employed by” relation 1390 and an “employs” relation 1395 (which is a reverse-relation of the “employed by” relation 1390). In addition, the “employee” concept 1300 includes an “employee name” property 1330 related by a “having name” relation 1335, and an “address” external abstraction 1350 related by the “working at address” relation 1355.

The “employee” concept 1300 is further related to a “territory” attribute 1380 via an “assigned to” relation 1385 and a second “assigned to” reverse concept 1386. The “territory” attribute 1380 is further related to a “territory description” property 1382 via a “named” relation 1383.

An exemplary utility of the concept model is seen in the creation of a near-free-form natural language database query. For example, a user seeking information and data maintained in a database can use the concept model for a particular domain to help him or her create valid-case inquiries. Thus, a user who wants information regarding the number of orders written by employees who are salesmen in Texas would, in viewing the cart, logically conclude that a valid search could be created by entering “list orders written by employees who are sales reps assigned to territory named Texas.” While this search string may or may not be precisely correct for a given domain model, depending on the intelligence of the underlying program, some ambiguities can be automatically corrected, while the user can be prompted to correct ambiguities in the search string.

One system of minimizing ambiguity is called the Minimally Explicit Grammar Pattern (MEGP). This is described in more detail in co-pending U.S. patent application Ser. No. 11/______, to Lane, et al. entitled NATURAL LANGUAGE MINIMALLY EXPLICIT GRAMMAR PATTERN filed on or about 31 Jan. 2008, and which is incorporated herein by reference in its entirety.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A domain-specific concept model architecture, comprising:
a plurality of concepts, each concept comprising at least one element, the plurality of concepts comprising a first concept and a second concept;
a plurality of relations, each relation defining how each concept relates to a property or an attribute, the plurality of relations comprising a first relation, a second relation, a third relation and a fourth relation;
each of the plurality of concepts having an identity associated with a macro meaning;
the first concept being logically mapped to the second concept via a first relation;
the second concept being logically mapped to the first concept via a second relation;
a plurality of attributes comprising a first attribute, each attribute defining information about the concept to which the attribute is related;
the first concept being logically mapped to a first attribute via a third relation;
the first attribute being logically mapped to the first concept via a fourth relation.

2. The architecture of claim 1 where the first concept is identifiable with at least one synonym.

3. The architecture of claim 1 where the first relation is identifiable with at least one synonym.

4. The architecture of claim 1 where the first relation is a verb phrase.

5. The architecture of claim 1 where the first attribute is identifiable with at least one synonym.

6. The architecture of claim 1 wherein the first concept is related to a first property value.

7. The architecture of claim 6 wherein the first property value has an equivalent property value identified by an alternative nomenclature.

8. The architecture of claim 1 wherein relations that relate concepts to concepts or concepts to attribute have corresponding reverse relations.

9. The architecture of claim 1 wherein the first concept and the second concept are mapped to a common external abstract, the first concept being mapped to the external abstract by a fifth relation, the second concept being mapped to the external abstract by a sixth relation.

10. The architecture of claim 6 wherein the first property value is an abstraction of an equivalent property value.

11. The architecture of claim 6 wherein the first property value is an abstraction of an equivalent property value, the equivalent property value being a natural language word.

12. The system of claim 1 wherein the first concept is a customer concept.

13. The system of claim 1 wherein the first concept is an order concept.

14. The system of claim 13 wherein the second concept is an employee concept having a sub-set property being a sales rep property.

15. The system of claim 14 wherein the first relation is defined as a “written by” relation, and the second relation is defined as a “who wrote” relation.

16. The system of claim 1 wherein the first attribute is a territory.

17. A domain-specific concept model architecture, comprising:
a plurality of concepts comprising a first concept and a second concept;
a plurality of relations, each relation defining how each concept relates to a property or an attribute, the plurality of relations comprising a first relation, a second relation, a third relation and a fourth relation;
each of the plurality of concepts having an identity associated with a macro meaning;
the first concept being logically mapped to the second concept via a first relation;
the second concept being logically mapped to the first concept via a second relation;
a plurality of attributes comprising a first attribute, each attribute defining information about the concept to which the attribute is related;
the first concept being logically mapped to a first attribute via a third relation;
the first attribute being logically mapped to the first concept via a fourth relation; and
the first concept defining a target concept; whereby
data may be identified by a natural language query made against a target database.

18. The system of claim 17 wherein each relation between two concepts has a corresponding reverse-relationship associated therewith.

19. The system of claim 17 wherein the first concept is defined as a target concept.
